(19) United States
(12) Patent Application Publication
(10) Pub. No.: US 2008/0281755 A1
(43) Pub. Date: Nov. 13, 2008

(54) SYSTEM AND METHOD FOR PROVIDING COMMERCIAL KITCHEN VENTILATION

(76) Inventor: Stephen L. BROWN, Dublin, OH (US)

Correspondence Address: STANDLEY LAW GROUP LLP, 495 METRO PLACE SOUTH, SUITE 210, DUBLIN, OH, 43017, US

(21) Appl. No.: 12/117,735

(22) Filed: May 8, 2008

Related U.S. Application Data
(60) Provisional application No. 60/916,687, filed on May 8, 2007.

(51) Int. Cl. G06Q 50/00; G06Q 20/00

(52) U.S. Cl. 705/39; 705/1

(57) ABSTRACT

A business method utilizing a Principal Entity to provide Commercial Kitchen Ventilation (CKV) systems including components such as hood and duct systems direct to owners of food service facilities. In one example, Principal Entity selects members of a contractor network, provides or arranges CKV instruction leading to CKV installer certification for members supports a continuing certification instruction program and facilitates CKV licensing of certified members by governmental code agencies. The Principal Entity may further create a business conduit facilitating participation of CKV component manufacturers in training that may lead to additional certifications of contractors as certified installers and/or servicers of manufacturer's components. The business conduit example may also provide tools and business systems to combine the purchasing power of members through the Principal Entity to facilitate the transfer of products and services between manufacturers, members and/or owners at greatly reduced costs yet with enhanced levels of service and code compliance.

### BACKGROUND OF THE INVENTION

FIG. 1 charts the predominant process that may be used by the Food Service Contractor (FSC) market to supply Commercial Kitchen Ventilation (CKV) systems to the food service industry today. With permission to quote from Mr. Rick Bagwell, President of Halton North America, the world's largest manufacturer of hood systems, “75% to 90% of all hoods and hood systems are sold by the FSC”. Referring to FIG. 1 the owner item 1 issues contract 2 to the selected FSC 3. FSC's are not required to hold any licenses, other than general business licenses, in order to sell CKV systems. Of the 10 largest FSC's in the United States, none maintain a staff or facilities to install CKV systems, nor do they hold licenses to do so. This lack of staff and licensing requires the FSC to begin a selection process 4 of a CKV system vendor sales representative 6 and issue purchase order 5 to said vendor. This process may be referred to by FSC's as a “one-call” purchase order because the FSC makes one call to the hood system sales representative and does not contract with the hood system installer or any other contractors. It is typically the responsibility of the sales representative 6 to coordinate selection of the hood 7, MUA or other supply devices 8, exhaust fans 9, fire suppression system 10 typically pre-piped by hood vendor in hood vendors product and with field hook-up completed by local subcontracted fire contractor 11, installation method 12 and installation contractor 13. The representative 6 then facilitates purchase orders to the responsible vendors and or contractors. At this point the installation contractor 13 and local fire contractor 14 assume responsibility for filing for and obtaining permits 14 and 15 respectively for their systems or services. In most cases these are somewhat misleading permits as the contractor 14 is neither furnishing nor designing the suppression system but rather only providing hook-up services however the permit requires the contractor 14 to assume jurisdictional responsibility for the complete system including design. The same responsibility process applies to contractor 13 who did not make the component selections or system design and is performing installation services only but by permit assumes jurisdictional responsibility for the complete installed CKV system. It is typical in today's market that many FSC CKV installation contractor's are not licensed HVAC contractors and purchase permits for CKV installation from a willing licensed contractor. It is also typical that many FSC CKV installation contractors do not have their own duct fabrication facilities and rely on a local duct fabricator 16 for fabrication services. Presentations at the 2007 ASHRAE Mid-Winter and 2007 RFMA meetings provided data from follow-up investigations to several serious restaurant fires. All of the investigations discovered improperly constructed CKV system exhaust duct increased the fire damage to each restaurant. Several instances have been found where installations that were approved by code and permitted were installed by contractors without specific CKV licensing, proper CKV training or correct materials resulted in leaking or improperly constructed grease ducts which proved to be a primary cause of several of the fires investigated. As FIG. 1 illustrates the FSC process may isolate an important CKV component—exhaust duct—from contractual agreements that tie the product to the owner's property and quality oversight. As the aforementioned presentations demonstrated the lack of oversight and complete CKV system responsibility can contribute to serious restaurant fires that risk employee and customer safety and cause considerable property damage.

FIG. 1 also illustrates the disconnect that exists between the owner, the CKV and the fixed-pipe fire suppression permits that are tied directly to the owner's property. This separates the owner from the permit and the contractor responsible for the permit, as well as system installation and follow-up service. In most CKV systems purchased using the FSC system, the building owner will not know if the contractor installing a CKV fire safety system in his/her facility is properly licensed or ever receive a certificate indicating proper insurance coverage. Many other layers of business processes unfortunately separate the owner from these resources.

Using this FSC system an owner's only contractual ties are with the FSC. The FSC handles all money paid by the owner for the system. The FSC collects the mark-up for the sale and pushes all responsibility to their vendor. The primary vendor is typically a sales office representing one or more CKV product manufacturers. Neither the FSC nor the sales office typically have staff, training or licensing to install, repair or service the components they sell. Since no contractual ties exist between the owner and the company that arrives on-site to install, repair and/or service the owner's hood system, the owner must work through the FSC business chain to deal with the installer for corrections or service.

It is typical in today's CKV marketplace for hood installers who participate in the FSC system to cover several states, or even the entire country. Response and service are often limited by the location and schedule of the installer, rather than being determined by the needs of the job schedule or need for service. The sales representative arranges the freight to deliver the manufactured products to the job site. These products may arrive as one shipment, or as several separate shipments. If the hood installer is not able to be at the site when the freight arrives, unloading may become the responsibility of the general contractor or other on-site contractors. This situation can create problems, especially when freight arrives damaged or incomplete. Those unloading the product have no stake in the product and often do not bother to properly document freight damage or deficiencies. Typical restaurant sites are compact and the potential for damage to products unloaded and left in parking lots or uninstalled inside the building is high. Furthermore, there exists a potential for theft of products or components left on site uninstalled.

FIG. 1 also indicates the added complication that may exist when the building comfort or HVAC system is provided by a separate licensed HVAC contractor 17. This is a prevalent condition in today's food service marketplace especially in the local restaurant market segment. Contractor 17 receives contract 18 from owner 1 independent of CKV contract 2 to FSC 3. A separate HVAC design 19 is completed by contractor 17 and a separate HVAC permit 20 (less CKV system) is filed by contractor 17. Contractor 17 selects heating and cooling equipment 21 and other exhaust fans 22 that may be used for restroom or bar exhaust or other general non CKV ventilation. Contractor orders respective components and installs components and duct systems at the site independent of the CKV system.

The complexities of the FSC system shown in FIG. 1 are highlighted when individual HVAC and CKV systems require respective startup 23 and 24, respective air balance 25 and 26. Even though these systems were purchased under separate contracts 2 and 18 the reliance of both systems on the proper operation of the other system is evident. The final issue for the owner 1 is the respective warranty and service 27 and 28 for the individual systems. In the event the building is too cold or too hot who determines if the problem is a CKV component that failed is preventing the HVAC system from functioning properly or vice versa? The maze of responsibility and parties invoiced in the transaction that do not have training, personnel, licenses stand in the way of any clear responsibility for owner 1 as to total system performance responsibility.

Typically, no complete building system operation or labor warranties are provided. If a product fails, the owner may call the FSC who, in turn, may call the sales representative who will, in turn, notify the manufacturer and/or the installer. The installer was responsible for installation only and did not sell or warranty the equipment or performance. As the sales representative is not staffed or trained to perform product repair or service, the issue of who pays for warranty labor is often a contentious issue. Eventually these issues are resolved, though frequently not without considerable time and effort and/or disappointment on the part of the owner and/or the owner's staff.

### BRIEF DESCRIPTION OF THE DRAWINGS

FIG. 1 is a chart of a predominant process that may be used by the Food Service Contractor (FSC) market to supply Commercial Kitchen Ventilation (CKV) systems to the food service industry.

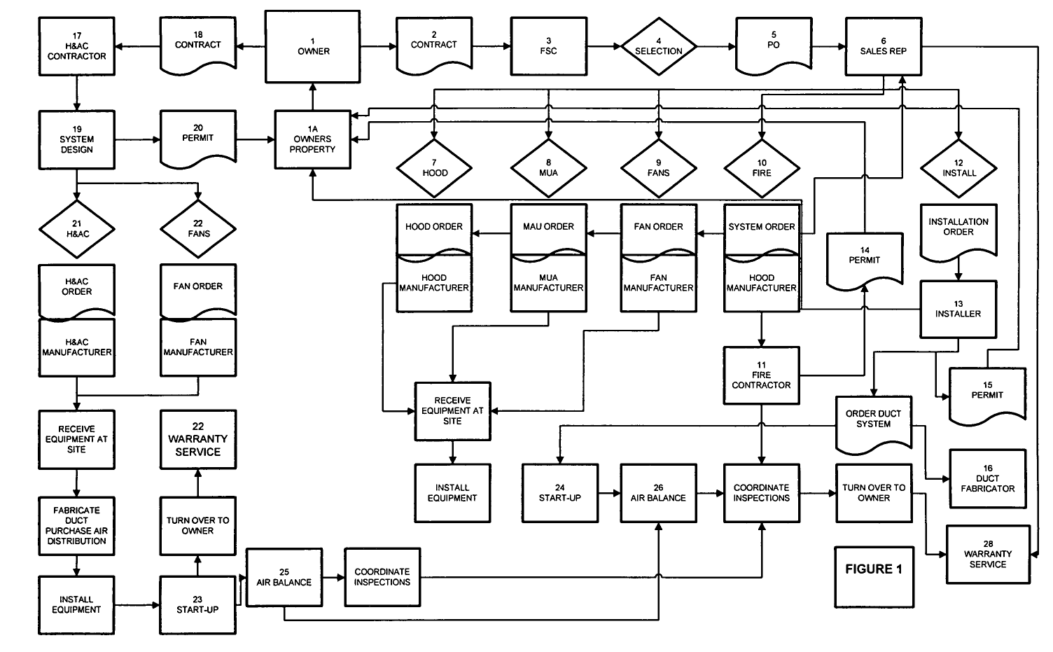

FIG. 2 is a chart of an exemplary embodiment of a business method of the present invention.

### SUMMARY AND DETAILED DESCRIPTION OF EXEMPLARY EMBODIMENT(S)

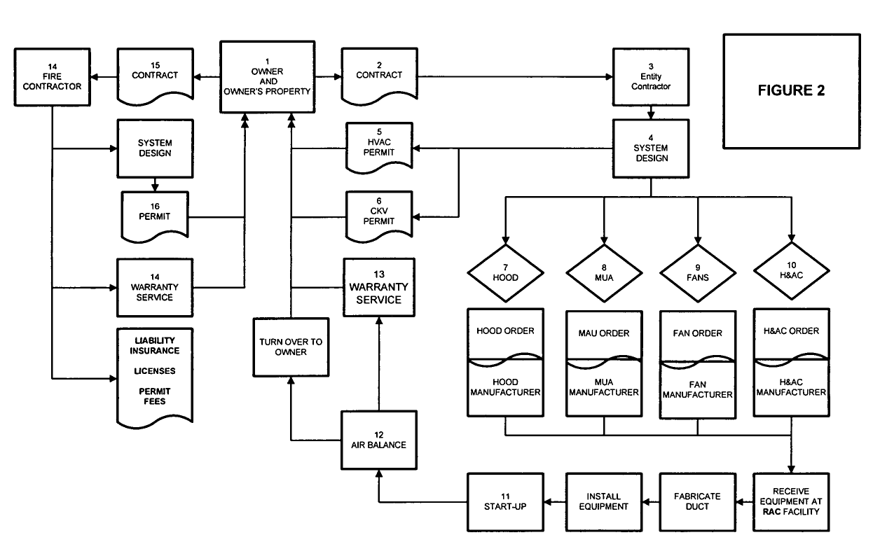

FIG. 2 indicates an exemplary embodiment of a business method of the present invention. In this exemplary embodiment, the Principal Entity (PE) has selected the Principal Entity Contractor (PEC3) and has verified the good business reputation, financial stability and proper insurance and business practices of PEC3. Further PEC3 is a participating member in PE's listed exhaust duct fabrication program and PEC3 will fabricate the duct at its own Inchscape (National Recognized Testing Laboratory) recognized duct fabrication faculty. PEC3 is further a licensed HVAC contractor who has successfully completed PE CKV training and certification and through PE has successfully completed CKV component manufacturer's training and certification. Furthermore the PE has arranged and PEC3 has received CKV licensing from the jurisdictional government agency as a licensed CKV contractor. The exemplary embodiment further assumes that the PEC has made the owner and code agency aware of the PE CKV performance test requirements and all parties have accepted the efficacy of the test method as a final demonstration of acceptable CKV system performance. The exemplary embodiment further provides the fire contractor 14 full responsibility for the fire suppression system through contract 15 direct with owner 1 and fire contractor 14 completes design and files for fire suppression permit 16 and provides all services including warranty services 14 and provides all required system insurance and pays all fire suppression fees.

In the exemplary embodiment the PE business conduit has been used to create lowest cost purchasing opportunities between PEC3 and all component manufacturers. In this exemplary embodiment the PE has established shipped product defect resolution, proper system design, selection, installation and warranty service techniques and processes between PEC3 and CKV component manufacturers. The PEC3 further uses PE on-line component order entry system to order components through or on behalf of the PE to bolster best price terms and conditions by combining purchase power of all PEC's with each component manufacture.

FIG. 2 clearly indicates the direct responsibility for the design, installation and performance of the complete CKV and HVAC systems by PEC3 to owner 1. FIG. 2 also clearly defines the responsibility for equipment start up 11 and air balance 12 services. Furthermore warranty services 13 for all CKV and all HVAC services are clearly defined in FIG. 2.

The exemplary embodiment greatly minimizes job site conflicts by establishing a certified and licensed CKV contractor the opportunity to assume a sole-source responsibility to owner 1. As a trained, certified and licensed CKV contractor certified by component manufactures to sell, install and service the latest CKV technologies such as UV and Total Kitchen HVAC® PEC3 may also bring to owner these latest CKV technologies required to meet today's environmental and energy concerns and costs.

The exemplary embodiment may further provide a public marketplace or organization through which certified CKV contractors may make their skills, products and services known to potential customers and where participating CKV component manufactures may make their goods and services available to these same potential customers. Further the marketplace may provide extended training facilities to CKV members and the facilities for CKV manufacturers to instruct and demonstrate design and installation and operation of their products to CKV contractors and potential members. Further the public marketplace may provide dispute resolution system that relies on industry experts representing customers, contractors and manufactures to provide a knowledgeable review of the disputed facts and provide a fairly arbitrated resolution. In additional the marketplace may provide systems that permit collection and distribution of evaluations of contractors' skills and services as well as manufactures product ratings by certified CKV contractors, manufactures and customers thus creating an ongoing evolution process for all goods and services.

The exemplary embodiment shown in FIG. 2 and described herein for contractor CKV certification, licensing and direct linkage between CKV component manufactures installing contractors and food service facility owners does not exist in today's CKV marketplace. A marketplace open to the public where skills can be attained, components demonstrated and goods and services evaluated would be of great benefit to the CKV industry.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1) A business method for providing contractor Commercial Kitchen Ventilation (CKV) certification comprising:
a) setting standards for and identifying contractors qualified for certification;
b) providing CKV system design knowledge required for certification;
c) providing instruction for proper CKV system installation knowledge and techniques required for certification;
d) providing instruction on interpretation of CKV related fire safety mechanical and building codes required for certification;
e) recognizing contractors or contractor's employees who have successfully completed training as certified CKV system designers;
f) recognizing contractors or contractor's employees who have successfully completed training as certified CKV system installers; and
g) recognizing contractors or contractor's employees who have successfully completed training as certified CKV system servicers.

2) The method of claim 1 wherein the training is supported by a continuing education program.

3) The method of claim 2 wherein information regarding changes in design and/or installation codes and standards are updating and disseminated to members as a component of a continuing education program.

4) The method of claim 2 wherein information regarding updates in CKV design practices is updated and training sessions modified.

5) The information of claim 3 where a training system is provided to disseminate updated information.

6) The training of claim 5 wherein successful completion of training may be required to continue certification.

7) The method of claim 1 further training materials to be used by contractors and or contractor's employees.

8) The method of claim 1 further on-line training system for use by contractors and or contractor's employees for the purpose of certification.

9) The method of claim 1 that further provides and/or facilitates and or participates in providing CKV certified contractors recognition by jurisdictional and or national code agencies or model code agencies as licensed and or anthologized CKV designers and/or installers and/or servicers.

10) The method of claim 9 further provides a process of demonstrating to code agencies the need for such licensing.

11) The method of claim 9 further provides a process of receiving code agency approval of certification process to be accepted as training and certification processes required for licensing.

12) The method of claim 9 that provides a process of presentation to code agencies to facilitate code agency approval of licensing process.

13) A method of claim 9 that provides continuing education for CKV licensed contractors required to maintain continuous license certification.

14) A method of claim 9 that provides training materials for continuing education.

15) A method of claim 3 that provides training for instructors of continuing CKV education courses.

16) A business method that facilitates a direct business relationship between CKV component manufacturers and certified CKV contractor members comprised of:
a) A training system that leads to certification of contractors by manufactures as certified system designers;
b) A training system that leads to certification of contractors by manufactures as direct purchasers and resellers of manufacturers' products;
c) A training system that leads to certification of contractors by manufactures as certified installers of manufacturers products; and
d) A training system that leads to certification of contractors by manufactures as certified servicers and/or warranty providers for manufacturers products.

17) The method of claim 16 further comprised of tools provided that permit multiple contractors to purchase direct from contractor as a single purchasing entity.

18) A method of claim 16 further comprised of instruction manuals and training guides to be used by manufactures and/or contractors.

19) A method of claim 16 further comprised of instruction manuals and training guides to be used by manufactures and/or contractors to implement purchasing systems.

20) A method of claim 2 further provides a shipped product defect process and or shipped product defect policy manuals to be used by manufacturers' and contractors.

21) A method of claim 2 further provides a direct Automated Clearing House account to transfer funds between manufactures and contractors.

22) A method of claim 2 that further provides pricing mechanisms that permit component vendors to treat products purchased from a diverse group of purchasers as a common or single business entity for the purposes of best pricing and/or terms of sale and delivery.

23) A method to create a business structure to represent the interests of organized certified CKV contractors and CKV component manufacturers comprised of:
a) Representation of organized parties for sales of goods and services;
b) An advertising outlet for organizations goods and services;
c) A public relations outlet for organizations contractors and/or manufacturers;
d) A training facility for certification and/or continuing education of CKV certified contractors and/or their employees;
e) A marketplace for public display of certified CKV contractors good and/or services; and
f) A marketplace for public display of CKV manufactures goods and/or services.

24) A method of claim 23 that further allows for certified contractors to join the organized structure either by paying dues, fees or other charges that may include franchisee fees.

25) A method of claim 23 that further allows for CKV manufacturers to subscribe to the services of certified contractors.

26) A method of claim 23 that further allows interested parties to access information regarding location of certified CKV manufacturers.

27) A method of claim 23 that further allows interested parties to access information regarding certifications held by CKV contractors.

28) A method of claim 23 that further allows interested parties to access a rating system of certified contractors to determine capabilities and rate performance.

29) A method of claim 28 that further allows customers of CKV certified contractors to rate the performance of the contractor's services based on customer personal experience.

30) A method of claim 28 that further allows customers to rate performance or satisfaction with CKV component manufactures products based on their personal experience of the customer with those products.

31) A method of claim 23 that further provides a method of settling disputes between certified CKV contractors, member CKV component manufactures and their customers through the business structure.

32) A method of claim 31 that further provides a panel of CKV industry experts comprised of contractor, manufacture and customer representatives to review and decide settlements between disputing parties.
